(19) United States
(12) Patent Application Publication
(10) Pub. No.: US 2017/0123142 A1
(43) Pub. Date: May 4, 2017

(54) BACKLIGHT SOURCE, METHOD FOR MANUFACTURING THE SAME, AND LIQUID CRYSTAL DISPLAY

(71) Applicant: SHENZHEN CHINA STAR OPTOELECTRONICS TECHNOLOGY CO., LTD., Shenzhen, Guangdong (CN)

(72) Inventor: Yanxue ZHANG, Shenzhen, Guangdong (CN)

(21) Appl. No.: 14/417,644

(22) PCT Filed: Dec. 3, 2014
(86) PCT No.: PCT/CN2014/092891

§ 371 Date: Jun. 6, 2016

(30) Foreign Application Priority Data
Nov. 14, 2014 (CN) 201410649892.8

(51) Int. Cl. F21V 8/00

(52) U.S. Cl. CPC G02B 6/0083; G02B 6/0091

(57) ABSTRACT

A backlight source, a method for manufacturing the backlight source, and a liquid crystal display are provided. The backlight source comprises a printed circuit board and a linear light source arranged on a surface of the printed circuit board, wherein the linear light source is configured as an integral module including a plurality of point light sources located in one and the same plane. The method comprises: step (a): providing a package trough member, and packaging the plurality of point light sources in the package trough member in such a manner that the plurality of point light sources are located in one and the same plane, so as to form a linear light source; and step (b): fixedly arranging the linear light source on the surface of the printed circuit board. The linear light source being configured as an integral module of the backlight source ensures excellent flatness thereof, thus improving light-emitting effects of the backlight source and display effects of the liquid crystal display.

### CROSS-REFERENCE TO RELATED APPLICATIONS

The present application claims benefit of Chinese patent application CN 201410649892.8, entitled “Backlight source, method for manufacturing the same, and liquid crystal display” and filed on Nov. 14, 2014, the entirety of which is incorporated herein by reference.

### FIELD OF THE INVENTION

The present disclosure relates to the field of liquid crystal display, and in particular, to a backlight source. The present disclosure further relates to a method for manufacturing the backlight source, and a liquid crystal display comprising the backlight source.

### BACKGROUND OF THE INVENTION

In a liquid crystal display, liquid crystals per se do not emit light, but are capable of modulating light from a backlight source, thus presenting graphics or characters on the liquid crystal display. Therefore, light-emitting effects of the backlight source will directly influence display effects of the liquid crystal display.

A backlight source usually includes a light guide plate, a printed circuit board (PCB), and a plurality of light-emitting diodes (LEDs) arranged on the PCB. These LEDs are generally arranged in the form of strips to form light-emitting lamp strips. Controlled by the PCB, the light-emitting lamp strips emit light to illuminate the whole display under the guidance of the light guide plate.

During manufacture of a backlight module, a surface-mount technology (SMT) is generally employed to arrange a plurality of LEDs on a PCB respectively to form light-emitting lamp strips. However, in mounting the LEDs, the problem of dislocation of the plurality of LEDs with respect to one another will inevitably arise, thus rendering flatness of the light-emitting lamp strips dissatisfactory. As shown in FIG. 1, LEDs 2 arranged on a printed circuit board I are dislocated with respect to one another. That is, these LEDs 2 have rather inferior flatness, thus deteriorating both light-emitting effects of the backlight source and display effects of the liquid crystal display.

### SUMMARY OF THE INVENTION

To solve the above problem, the present disclosure provides a backlight source. The backlight source comprises a linear light source being configured as an integral module, which ensures excellent flatness of the linear light source, and thus enhances both light-emitting effects of the backlight source and display effects of the liquid crystal display.

According to a first aspect of the present disclosure, a backlight source is provided, comprising a printed circuit board and a linear light source arranged on a side surface of the printed circuit board, wherein the linear light source is configured as an integral module including a plurality of point light sources located in one and the same plane.

In the backlight source according to the present disclosure, since the linear light source is pre-configured as an integral module, with a plurality of point light sources being located in one and the same plane, the plurality of point light sources will still be maintained in its original state without being affected by any external factor after the linear light source is mounted on the printed circuit board. That is, these point light sources will invariably stay in one and the same plane, thereby improving both light-emitting effects of the backlight source and display effects of the liquid crystal display. In addition, the linear light source being configured as an integral module can be more readily mounted on the printed circuit board than separate point light sources that have to be mounted on the printed circuit board one by one, thus increasing manufacturing efficiency of the liquid crystal display.

In one embodiment, the linear light source comprises a package trough member, and the plurality of point light sources is packaged in the package trough member in such a manner as being located in one and the same plane. In one preferred embodiment, the point light sources are in the form of a plurality of light-emitting diodes. The package trough member can enhance the integrity of the linear light source, and protect the light-emitting diodes packaged therein.

In one embodiment, the package trough member is in the form of a straight line, and the plurality of point light sources is arranged in a straight line along an axial direction of the package trough member. Under the guidance of the package trough member in the form of a straight line, the light-emitting diodes can be strictly arranged in a straight line to form the linear light source. In one preferred embodiment, the plurality of light-emitting diodes is connected to one another via a copper wire. Since the plurality of light-emitting diodes is strictly located in a straight line, i.e., the wire for connecting the plurality of light-emitting diodes can be formed without bends, a copper wire can be selected to replace a gold wire that is used in a traditional backlight source, thereby significantly reducing costs of the backlight source and the liquid crystal display.

In one embodiment, the backlight source further comprises a light guide plate, wherein the light guide plate has a light-incident surface facing the linear light source. In one preferred embodiment, a coupling distance between the light guide plate and the linear light source is zero. Since these point light sources have excellent flatness, coupling distances from the light-incident surface of the light guide plate to the point light sources are all the same and can be zero. This can significantly improve the coupling efficiency of the light guide plate, and thereby further improves display effects of the liquid crystal display.

According to a second aspect of the present disclosure, a method for manufacturing the backlight source as described above is provided, comprising the following steps: step (a): providing a package trough member, and packaging the plurality of point light sources in the package trough member in such a manner that the plurality of point light sources are located in one and the same plane, so as to form a linear light source; and step (b): fixedly arranging the linear light source on the side surface of the printed circuit board.

According to the method of the present disclosure, the linear light source can be manufactured separately from the backlight source, which enables efficient and batch production of the linear light source. In addition, the linear light source as a whole can be efficiently formed on the printed circuit board. As such, the manufacturing efficiency of the backlight source can be significantly increased.

In one embodiment, in step (a), the plurality of point light sources is arranged in a straight line along an axial direction of the package trough member.

In one embodiment, the backlight source further comprises a light guide plate, which has a light-incident surface facing the linear light source, and a coupling distance between the light guide plate and the linear light source is zero. Thus, the coupling efficiency of the light guide plate can be significantly improved, thereby further improving display effects of the liquid crystal display.

According to a third aspect of the present disclosure, a liquid crystal display is provided, comprising the backlight source as described above.

Compared with the prior art, the present disclosure brings about the following advantages. At the outset, the backlight source of the present disclosure is pre-configured as an integral module, with a plurality of point light, sources being located in one and the same plane along a straight line, thereby improving both light-emitting effects of the backlight source and display effects of the liquid crystal display. Besides, the linear light source being configured as an integral module can be more readily mounted on the printed circuit board than separate point light sources that have to be mounted on the printed circuit board one by one, thus increasing production efficiency. In addition, the coupling efficiency of the light guide plate can be improved according to the backlight source of the present disclosure, thereby further improving display effects of the liquid crystal display.

### BRIEF DESCRIPTION OF THE DRAWINGS

In the following, the present disclosure will be illustrated in detail in connection with embodiments and accompanying drawings, in which:

FIG. 1 schematically shows the structure of a backlight source in the prior art;

FIG. 2 schematically shows the structure of a backlight source according to the present disclosure; and

FIG. 3 schematically shows a partial view of the structure of a liquid crystal display according to the present disclosure.

In the drawings, the same components are indicated with the same reference signs. The figures are not drawn in accordance with an actual scale.

### DETAILED DESCRIPTION OF THE EMBODIMENTS

The present discloser Will be further explained in conjunction with the accompanying drawings.

FIG. 1 schematically shows the structure of a backlight source in the prior art. As indicated in FIG. 1, light-emitting diodes 2 arranged on a printed circuit board 1 are dislocated with respect to one another. That is, these light-emitting diodes 2 have rather dissatisfactory flatness.

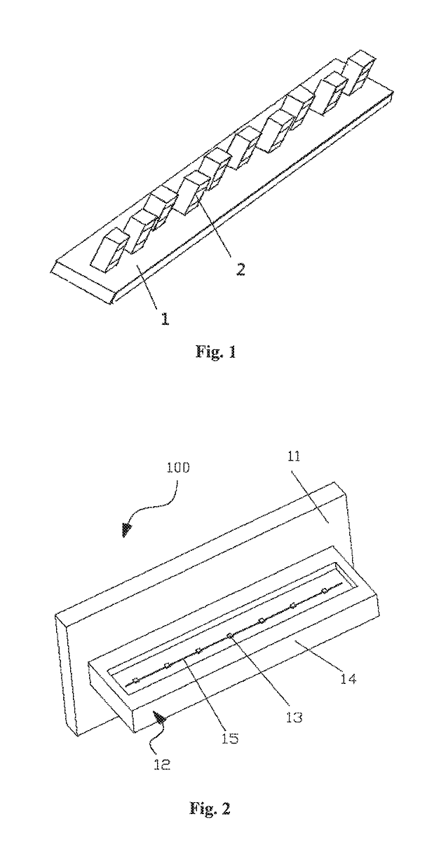

FIG. 2 schematically shows the structure of a backlight source 100 according to the present disclosure. As indicated in FIG. 2, the backlight source 100 comprises a printed circuit board 11, and a linear light source 12 arranged on a surface of the printed circuit board 11. The linear light source 12 is configured as an integral module, arranged therein with a plurality of point light sources 13 that are located in one and the same plane. In one embodiment, the point light sources 13 can be selected as light-emitting diodes.

Specifically, as FIG. 2 shows, the linear light source 12 includes a package trough member 14, and a plurality of light-emitting diodes 13 arranged in the package trough member 14. It should be particularly noted that theses light-emitting diodes 13 are all located in one and the same plane. The package trough member 14 substantially forms a carrier for the plurality of light-emitting diodes 13, and thereby ensures integrity of the linear light source 12. When the linear light source 12 and the printed circuit board 11 are fit together, or when a liquid crystal display is being assembled, the plurality of light-emitting diodes 13 packaged in the package trough member 14 will not alter in flatness, thus enabling the plurality of light-emitting diodes 13 arranged in the liquid crystal display to stay in one and the same plane with favorable flatness.

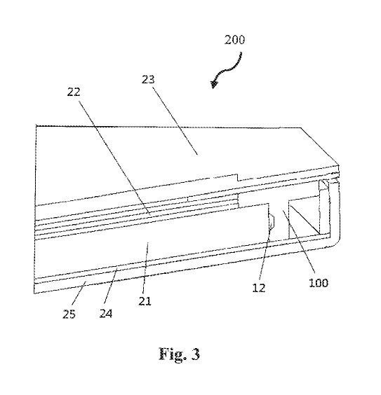

FIG. 3 schematically shows a liquid crystal display 200 provided with the backlight source 100. The liquid crystal display 200 further comprises a light guide plate 21, an optical diaphragm 22 arranged on a light-exiting surface of the light guide plate 21, a liquid crystal panel 23, and a reflective sheet 24 and a rear panel 25 both arranged below the light guide plate 21. It should be particularly noted that the light guide plate 21 has a light-incident surface facing the linear light source 12. Because the plurality of light-emitting diodes 13 is located in one and the same plane, the coupling distances from the light-emitting diodes 13 to the light-incident surface of the light guide plate 21 are all the same. Preferably, the coupling distance from the linear light source 12 or the plurality of light-emitting diodes 13 to the light-incident surface of the light guide plate 21 can be zero. This can significantly improve coupling efficiency of the light guide plate 21, and further improve display effects of the liquid crystal display 200.

As FIG. 2 further shows, the package trough member 14 can be preferably in the form of a straight line. Thus, the plurality of light-emitting diodes 13 can be arranged in a straight line along an axial direction of the package trough member 14. In such structure, a wire for connecting the plurality of light-emitting diodes 13 can be formed straight without bends. Therefore, a wire 15 for connecting the plurality of light-emitting diodes 13 can be selected merely based on its resistance, while toughness thereof is unnecessary to be considered. Preferably, the wire 15 can be made of copper, instead of gold which is used in a traditional backlight source, thereby significantly reducing production costs of the backlight source 100 and the liquid crystal display 200. Those skilled in the art can, according to actual situations, also select other metal wires of low resistance, such as a silver wire, an aluminum wire, etc.

In manufacturing the backlight source 100 according to the present disclosure, the package trough member 14 is first provided, and the plurality of light-emitting diodes 13 are packaged in the package trough member 14. The plurality of light-emitting diodes 13 should be located in one and the same plane, and preferably arranged in a straight line along an the axial direction of the package trough member 14, so as to achieve the aforementioned beneficial effects of the backlight source 100. Subsequently, the linear light source 12 is fixedly arranged on the surface of the printed circuit board 11.

According to the manufacturing method of the present disclosure, the linear light source 12 can be produced as a separate component, and then mounted, as an integral whole, to the printed circuit board 11 during manufacture of the backlight source 100. This enables high efficient and batch production of the linear light source 12. Besides, since the linear light source 12 is an integral whole, it can be mounted to the printed circuit board 11 efficiently, thereby substantially improving the production efficiency of the backlight source 100.

Although the present disclosure has been described with reference to preferred embodiments, various modifications and variants to the present disclosure may be made by anyone skilled in the art, without departing from the scope and spirit of the present disclosure. In particular, as long as there is no structural conflict, various embodiments as well as the respective technical features mentioned herein may be combined with one another in any manner. The present disclosure is not limited to the specific embodiments disclosed herein, but rather includes all the technical solutions falling within the scope of the claims.

1. A backlight source, comprising a printed circuit board and a linear light source arranged on a surface of the printed circuit board, wherein the linear light source is configured as an integral module including a plurality of point light sources located in one and the same plane.

2. The backlight source according to claim 1, wherein the linear light source comprises a package trough member, and the plurality of point light sources is packaged in the package trough member in such a manner as being located in one and the same plane.

3. The backlight source according to claim 2, wherein the package trough member is in the form of a straight line, and the plurality of point light sources is arranged in a straight line along an axial direction of the package trough member.

4. The backlight source according to claim 2, wherein the point light sources are in the form of a plurality of light-emitting diodes.

5. The backlight source according to claim 4, wherein the plurality of light-emitting diodes is connected to one another via a copper wire.

6. The backlight source according to claim 1, further comprising a light guide plate, wherein the light guide plate has a light-incident surface facing the linear light source.

7. The backlight source according to claim 6, wherein a coupling distance between the light guide plate and the linear light source is zero.

8. The backlight source according to claim 2, further comprising a light guide plate, wherein the light guide plate has a light-incident surface facing the linear light source.

9. The backlight source according to claim 8, wherein a coupling distance between the light guide plate and the linear light source is zero.

10. A method for manufacturing a backlight source, wherein the backlight source comprises a printed circuit board and a linear light source arranged on a surface of the printed circuit board, the linear light source being configured as an integral module including a plurality of point light sources located in one and the same plane, and wherein the method comprises the following steps:
step (a): providing a package trough member, and packaging the plurality of point light sources in the package trough member in such a manner that the plurality of point light sources are located, in one and the same plane, so as to form the linear light source; and
step (b): fixedly arranging the linear light source on the surface of the printed, circuit board.

11. The method according to claim 10, wherein in step (a), the plurality of point light sources is arranged in a straight line along an axial direction of the package trough member.

12. The method according to claim 10, wherein the backlight source further comprises a light guide plate, which has a light-incident surface facing the linear light source, and wherein a coupling distance between the light guide plate and the linear light source is zero.

13. The method according to claim 11, wherein the backlight source further comprises a light guide plate, which has a light-incident surface facing the linear light source, and
wherein a coupling distance between the light guide plate and the linear light source is zero.

14. A liquid crystal display, comprising a backlight source, which includes a printed circuit board and a linear light source arranged on a surface of the printed circuit board, wherein the linear light source is configured as an integral module including a plurality of point light sources located in one and the same plane.
